(19) United States
(12) Patent Application Publication
(10) Pub. No.: US 2025/0270876 A1
(43) Pub. Date: Aug. 28, 2025

(54) Decorative Window Insulation Device

(71) Applicants: Joshua Hernandez, New Britain, CT (US); Madeline Guzman, New Britain, CT (US)

(72) Inventors: Joshua Hernandez, New Britain, CT (US); Madeline Guzman, New Britain, CT (US)

(21) Appl. No.: 18/629,342

(22) Filed: Apr. 8, 2024

Related U.S. Application Data
(60) Provisional application No. 63/556,546, filed on Feb. 22, 2024.

(51) Int. Cl. E06B 7/28; G09F 7/18

(52) U.S. Cl. CPC E06B 7/28; G09F 7/18; G09F 2007/1852; G09F 2007/1856

(57) ABSTRACT

A decorative window insulation device is provided. The device is designed to fit over or inside a window for insulation purposes, comprising a body made from materials such as reflective aluminized polyester, nylon, insulating foam, or cardboard. The front and rear surfaces of the body may include decorative indicia and are equipped with fasteners, such as adhesive hook and loop fasteners, magnets, or adhesives, for secure attachment to a window frame or wall surface. This configuration not only enhances the aesthetic appeal of the device but also ensures its stability near the window to effectively insulate it and prevent drafts, as well as the ingress of excessive heat or cold through the window.

### CROSS-REFERENCE TO RELATED APPLICATION

The present application claims priority to, and the benefit of, U.S. Provisional Application No. 63/556,546, which was filed on Feb. 22, 2024, and is incorporated herein by reference in its entirety.

### FIELD OF THE INVENTION

The present invention relates generally to the field of window insulation. More specifically, the present invention relates to an insulated body comprised of decorative indicia on both sides, wherein the body can be attached to a window frame or window via at least one fastener. Accordingly, the present disclosure makes specific reference thereto. Nonetheless, it is to be appreciated that aspects of the present invention are also equally applicable to other like applications, devices, and methods of manufacture.

### BACKGROUND

The absence of proper insulation in the windows of both residential and commercial properties can result in the unwelcome occurrence of drafts. These drafts not only compromise the comfort of the inhabitants but also impose a significant financial burden to counteract the infiltration of external temperatures. Buildings plagued by drafts find themselves caught in a continuous struggle to maintain an optimal indoor climate, often resulting in escalated utility expenses. This financial strain is particularly evident as property owners attempt to mitigate the effects of both hot and cold air that seeps in through the windows, challenging the efficiency of heating and cooling systems.

In an effort to address these issues, individuals might resort to temporary solutions, employing makeshift insulation techniques using readily available materials like plastic sheeting. Such DIY approaches are adopted with the intention of sealing off the windows and preventing the entry of drafts. However, despite these efforts, these solutions often fall short of providing a permanent fix. The reality is that these stop-gap measures, while perhaps reducing the immediate impact of drafts, do not effectively eliminate the problem. The insufficiency of these methods lies in their inability to create a completely airtight seal around the window frames, thereby allowing drafts to persistently penetrate the barrier and enter the living space. In addition, these methods are often unsightly.

Therefore, there exists a long-felt need in the art for a device for insulating windows. There also exists a long-felt need in the art for a decorative window insulation device. More specifically, there exists a long-felt need in the art for a decorative window insulation device that prevents window drafts and insulates a window from external temperatures. Further, there exists a long-felt need in the art for a decorative window insulation device that prevents window drafts and insulates a window from external temperatures wherein the device is visually appealing.

The subject matter disclosed and claimed herein, in one embodiment thereof, comprises a decorative window insulation device. The device is designed to fit over or inside a window for insulation purposes, comprising a body made from materials such as reflective aluminized polyester, nylon, insulating foam, or cardboard. The front and rear surfaces of the body may include decorative indicia and are equipped with fasteners, such as adhesive hook and loop fasteners, magnets, or adhesives, for secure attachment to a window frame or wall surface. This configuration not only enhances the aesthetic appeal of the device but also ensures its stability near the window to effectively insulate it and prevent drafts, as well as the ingress of excessive heat or cold through the window. In this manner, the decorative window insulation device of the present invention accomplishes all the foregoing objectives and provides a device that prevents window drafts and insulates a window from external temperatures. Further, the device does so while remaining visually appealing.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a decorative window insulation device comprised of a body. The body may be any size, shape, and configuration that allows the body to fit over or inside a window. The body is preferably made from an insulating material. The front surface of the body may be comprised of at least one indicia that provides a decorative visual effect to the device. The front surface may also be comprised of at least one fastener that allows the front surface to attach to a window frame, around a window to a wall surface, or within a frame to a window. The rear surface of the body may be comprised of at least one indicia that provides a decorative visual effect to the device. The rear surface may also be comprised of at least one fastener that allows the front surface to attach to a window frame, around a window to a wall surface, or within a frame to a window. As a result of the placement of the device in/around a window, the device prevents drafts and prevents excess heat or cold from entering windows. Further, the indicia ensures the device remains visually appealing.

The present invention is also comprised of a method of using the device. First, a device is provided comprised of a body made from an insulating material, the body comprised of a front surface comprised of a first indicia and a first fastener, and a rear surface comprised of a second indicia. Then, the body can be attached to a window frame, a window, or a wall around a window via the fastener.

Accordingly, the decorative window insulation device of the present invention is particularly advantageous as it provides a device that prevents window drafts and insulates a window from external temperatures. Further, the device does so while remaining visually appealing. In this manner, the decorative window insulation device overcomes the limitations of existing window insulation devices and methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a decorative window insulation device of the present invention in accordance with the disclosed architecture;

FIG. 2 illustrates a rear view of one potential embodiment of a decorative window insulation device of the present invention in accordance with the disclosed architecture;

FIG. 3 illustrates a rear view of one potential embodiment of a decorative window insulation device of the present invention while attached over a window to a window frame in accordance with the disclosed architecture;

FIG. 4 illustrates a flowchart of a method of using one potential embodiment of a decorative window insulation device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for insulating windows. There also exists a long-felt need in the art for a decorative window insulation device. More specifically, there exists a long-felt need in the art for a decorative window insulation device that prevents window drafts and insulates a window from external temperatures. Further, there exists a long-felt need in the art for a decorative window insulation device that prevents window drafts and insulates a window from external temperatures wherein the device is visually appealing.

The present invention, in one exemplary embodiment, is comprised of a decorative window insulation device. The device is comprised of a body that may be any size, shape, and configuration that allows the body to fit over or inside a window. The body is preferably made from an insulating material, wherein the front surface of the body may be comprised of at least one indicia that provides a decorative visual effect to the device. The front surface may also be comprised of at least one fastener that allows the front surface to attach to a window frame, around a window to a wall surface, or within a frame to a window. The rear surface of the body may be comprised of at least one indicia that provides a decorative visual effect to the device. The rear surface may also be comprised of at least one fastener that allows the front surface to attach to a window frame, around a window to a wall surface, or within a frame to a window. As a result of the placement of the device in/around a window, the device prevents drafts and prevents excess heat or cold from entering windows. Further, the indicia ensures the device remains visually appealing.

The present invention is also comprised of a method of using the device. First, a device is provided comprised of a body made from an insulating material, the body comprised of a front surface comprised of a first indicia and a first fastener, and a rear surface comprised of a second indicia. Then, the body can be attached to a window frame, a window, or a wall around a window via the fastener.

Accordingly, the decorative window insulation device of the present invention is particularly advantageous as it provides a device that prevents window drafts and insulates a window from external temperatures. Further, the device does so while remaining visually appealing. In this manner, the decorative window insulation device overcomes the limitations of existing window insulation devices and methods known in the art.

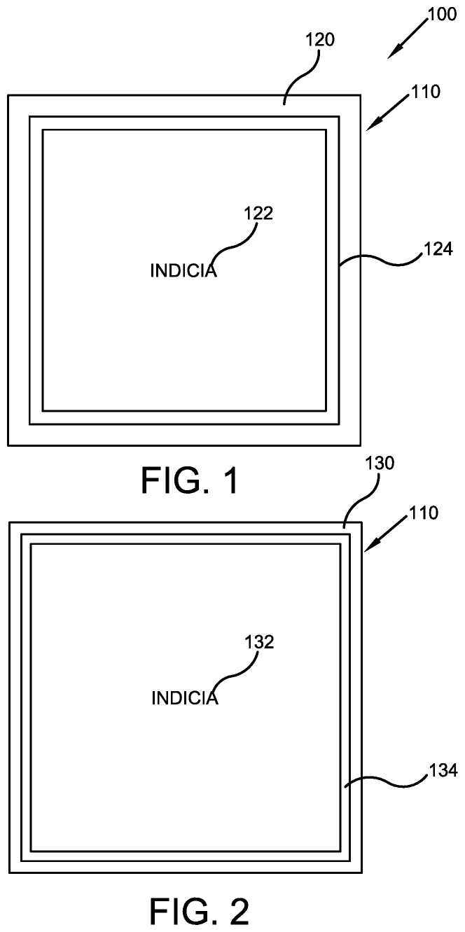

Referring initially to the drawings, FIG. 1 illustrates a front view of one potential embodiment of a decorative window insulation device 100 of the present invention in accordance with the disclosed architecture. The device 100 is comprised of a body 110. The body 110 may be any size, shape, and configuration that allows the body 110 to fit over or inside a window 10. The body 110 may be shaped to resemble an object, an image, a shape, a symbol, etc., in different embodiments. The body 110 is preferably made from an insulating material such as, but not limited to, a reflective aluminized polyester, a nylon, an insulating foam, a cardboard, etc. In one embodiment, a front surface 120 of the body 110 is made from a reflective material, and a rear surface of the body 110 is comprised of an insulating material. This allows a specific surface 120, 130 to be positioned inward-facing or outward-facing relative to a window 10 depending on if a user desires to cool or insulate the interior of a structure the window 10 is located on.

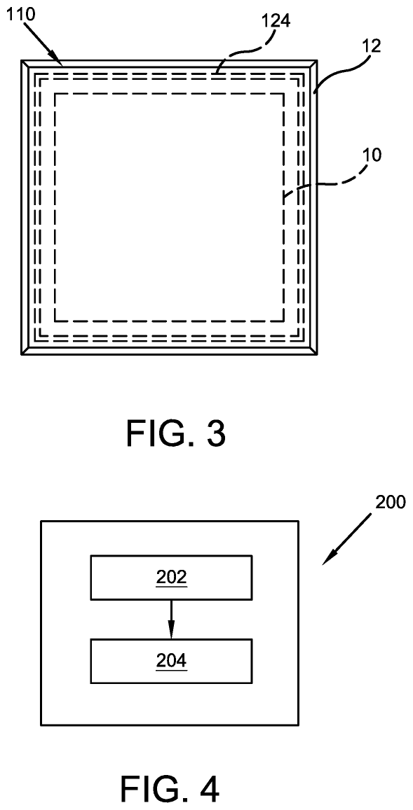

The front surface 120 may be comprised of at least one indicia 122. The indicia 122 may include, but is not limited to, a word, a symbol, a picture, an image, a pattern, etc., that provides a decorative visual effect to the device. The front surface 120 may also be comprised of at least one fastener 124. The fastener 124 allows the front surface 120 to attach to a window frame 12 (as seen in FIG. 3), around a window 10 to a wall surface, or within a frame to a window 10. In this manner, the body 110 is secured in position near the window 10 to insulate the window. The fastener 124 is preferably an adhesive hook and loop fastener, but may be any fastener type such as, but not limited to, a magnet, an adhesive, etc. The fastener 124 preferably encircles a perimeter of the surface 120, but may be positioned in any location, orientation, etc.

The rear surface 130 may be comprised of at least one indicia 132, as seen in FIG. 2. The indicia 132 may include, but is not limited to, a word, a symbol, a picture, an image, a pattern, etc., that provides a decorative visual effect to the device. The rear surface 130 may also be comprised of at least one fastener 134. The fastener 134 allows the rear surface 130 to attach to a window frame 12, around a window 10 to a wall surface, or within a frame to a window 10. In this manner, the body 110 is secured in position near the window 10 to insulate the window. The fastener 134 is preferably an adhesive hook and loop fastener, but may be any fastener type such as, but not limited to, a magnet, an adhesive, etc. The fastener 134 preferably encircles a perimeter of the surface 130, but may be positioned in any location, orientation, etc.

As a result of the placement of the device 100 in/around a window 10, the device prevents drafts and prevents excess heat or cold from entering windows. Further, the indicia 122, 132 ensures the device 100 remains visually appealing. In different embodiments, the indicia 122, 132 may be the same or different indicia.

The present invention is also comprised of a method of using 200 the device 100, as seen in FIG. 4. First, a device 100 is provided comprised of a body 110 made from an insulating material, the body 110 comprised of a front surface 120 comprised of a first indicia 122 and a first fastener 124 and a rear surface 130 comprised of a second indicia 132 [Step 202]. Then, the body 110 can be attached to a window frame 12, a window 10, or a wall around a window via the fastener 124 [Step 204].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “decorative window insulation device” and “device” are interchangeable and refer to the decorative window insulation device 100 of the present invention.

Notwithstanding the foregoing, the decorative window insulation device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the decorative window insulation device 100 as shown in the FIGS. are for illustrative purposes only, and that many other sizes and shapes of the decorative window insulation device 100 are well within the scope of the present disclosure. Although the dimensions of the decorative window insulation device 100 are important design parameters for user convenience, the decorative window insulation device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A decorative window insulation device comprising:
a body comprised of an insulating material, the body comprised of:
a front surface comprised of a first indicia and a fastener; and
a rear surface comprised of a second indicia.

2. The decorative window insulation device of claim 1, wherein a shape of the body is comprised of an object, an image, a shape, or a symbol.

3. The decorative window insulation device of claim 1, wherein the body is comprised of a reflective aluminized polyester, a nylon, an insulating foam, or a cardboard.

4. The decorative window insulation device of claim 1, wherein the first indicia is comprised of a word, a symbol, a picture, an image, or a pattern.

5. The decorative window insulation device of claim 1, wherein the second indicia is comprised of a word, a symbol, a picture, an image, or a pattern.

6. The decorative window insulation device of claim 1, wherein the fastener is comprised of an adhesive hook and loop fastener.

7. The decorative window insulation device of claim 1, wherein the fastener is comprised of an adhesive fastener.

8. The decorative window insulation device of claim 1, wherein the fastener is comprised of a magnet fastener.

9. A decorative window insulation device comprising:
a body comprised of an insulating material, the body comprised of:
a front surface comprised of a first indicia and a first fastener; and
a rear surface comprised of a second indicia and a second fastener.

10. The decorative window insulation device of claim 9, wherein the first indicia is comprised of a word, a symbol, a picture, an image, or a pattern.

11. The decorative window insulation device of claim 10, wherein the second indicia is comprised of a word, a symbol, a picture, an image, or a pattern that differs from the first indicia.

12. The decorative window insulation device of claim 9, wherein a shape of the body is comprised of an object, an image, a shape, or a symbol.

13. The decorative window insulation device of claim 9, wherein the body is comprised of a reflective aluminized polyester, a nylon, an insulating foam, or a cardboard.

14. The decorative window insulation device of claim 9, wherein the first fastener is comprised of an adhesive hook and loop fastener.

15. The decorative window insulation device of claim 9, wherein the first fastener is comprised of an adhesive fastener.

16. The decorative window insulation device of claim 9, wherein the first fastener is comprised of a magnet fastener.

17. The decorative window insulation device of claim 9, wherein the second fastener is comprised of an adhesive hook and loop fastener.

18. The decorative window insulation device of claim 9, wherein the second fastener is comprised of an adhesive fastener.

19. The decorative window insulation device of claim 9, wherein the second fastener is comprised of a magnet fastener.

20. A method of using a decorative window insulation device, the method comprising the following steps:
providing a decorative window insulation device comprised of a body made from an insulating material, the body comprised of a front surface comprised of a first indicia and a first fastener and a rear surface comprised of a second indicia; and
attaching the body to a window frame, a window, or a wall around a window via the fastener.
